(19) United States
(12) Patent Application Publication
(10) Pub. No.: US 2020/0079010 A1
(43) Pub. Date: Mar. 12, 2020

(54) ADDITIVE MANUFACTURING METHOD USING AN ENERGY SOURCE AND VARYING BUILD MATERIAL SPACINGS AND APPARATUS

(71) Applicant: Hewlett-Packard Development Company, L.P., Houston, TX (US)

(72) Inventors: Juan Manuel ZAMORANO, Barcelona (ES); Sergio DE SANTIAGE DOMINGUEZ, Barcelona (ES); Marina FERRAN FARRES, Barcelona (ES)

(73) Assignee: Hewlwtt-Packard Development Company, L.P., Houston, TX (US)

(21) Appl. No.: 15/746,782

(22) PCT Filed: Oct. 29, 2015
(86) PCT No.: PCT/EP2015/075142

§ 371 Date: Jan. 22, 2018

(51) Int. Cl. B29C 64/153; B29C 64/245; B29C 64/205; B29C 64/264; B29C 64/232; B29C 64/393

(52) U.S. Cl. CPC B29C 64/153; B29C 64/245; B29C 64/205; B33Y 10/00; B29C 64/232; B29C 64/393; B29C 64/264

(57) ABSTRACT

In an example, a method comprises providing a layer of build material on a support, and applying energy to the layer of build material using an energy source. The method may further comprise reducing a spacing between the energy source and the support and following the reduction of the spacing, applying energy to the layer of build material using the energy source to cause fusion in at least part of the layer of build material.

### BACKGROUND

Additive manufacturing systems that generate three-dimensional objects on a layer-by-layer basis have been proposed as a potentially convenient way to produce three-dimensional objects.

Additive manufacturing techniques may generate a three-dimensional object through the solidification of a build material. In examples of such techniques, build material is supplied in a layer-wise manner and the solidification method includes heating the layers of build material to cause fusion in selected regions. In other techniques, chemical solidification methods may be used.

### BRIEF DESCRIPTION OF DRAWINGS

Non-limiting examples will now be described with reference to the accompanying drawings, in which:

FIG. 1 is a flowchart of an example of a method for use in additive manufacturing;

FIGS. 2A and 2B are a simplified schematic showing an example of the effect of changing a spacing between an energy source and a support for build material;

FIG. 3 is a flowchart of another example of a method for use in additive manufacturing;

FIG. 4 is a flowchart of another example of a method for use in additive manufacturing;

FIG. 5 is a simplified schematic of an example of an additive manufacturing apparatus; and

FIG. 6 is a simplified schematic of an example of a processor associated with a computer readable medium.

### DETAILED DESCRIPTION

Additive manufacturing techniques may generate a three-dimensional object through the solidification of a build material. In some examples, the build material is a powder-like granular material, which may for example be a plastic, ceramic or metal powder and the properties of generated objects may depend on the type of build material and the type of solidification mechanism used. Build material may be deposited, for example on a print bed and processed layer by layer, for example within a fabrication chamber.

In some examples, selective solidification is achieved through directional application of energy, for example using a laser or electron beam, which results in solidification of build material where the directional energy is applied. In other examples, at least one print agent may be selectively applied to the build material. For example, a coalescing agent (also termed a ‘fusing agent’) may be selectively distributed onto portions of a layer of build material in a pattern derived from data representing a slice of a three-dimensional object to be generated (which may for example be generated from structural design data). The coalescing agent may have a composition such that, when energy (for example, heat) is applied to the layer, the build material coalesces (i.e. fuses) and solidifies to form a slice of the three-dimensional object in accordance with the pattern. In other examples, coalescence may be achieved in some other manner.

Examples of apparatus for additive manufacturing which utilise ‘inkjet’ techniques to disperse such agents have been proposed. Such apparatus may comprise a print agent distributor for example in the form of a print head. An example print agent distributor comprises a set of nozzles and a mechanism for ejecting a selected agent as a fluid, for example a liquid, through the nozzles.

Where an energy source is used to create fusion, in some examples, the build material is preheated. This may for example reduce the energy consumed in causing fusion, and/or may reduce unwanted effects such as shrinkage or deformation of a generated object. Such preheating may be carried out by an energy source which may comprise a heat source such as a short wave, for example infrared, lamp or lamp array, or using a defocused directional energy source such as an electron beam, which may then subsequently be used as a focussed beam to cause selective fusion. Generally, the amount of energy used to perform preheating is lower than that used to cause fusion.

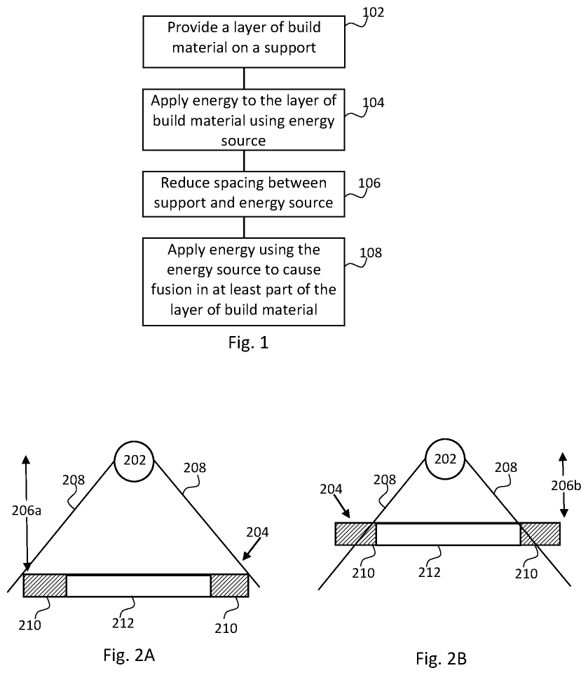

FIG. 1 is a flow chart of an example of a method which may be used in additive manufacturing. In block 102, a layer of build material is provided on a support. In some examples, the support may be a print bed of an additive manufacturing apparatus. In some examples, the support comprises a print bed bearing at least one layer of build material. In block 104, the layer of build material has energy applied thereto from an energy source. In some examples, the energy source may comprise a heat source, such as one or an array of LED lamps. In some examples, in carrying out block 104, the energy may be applied to preheat the build material, and as such the energy incident on the build material may be below a threshold to cause fusion of the build material. In block 106, a spacing between the energy source and the support is reduced. In block 108, following the reduction in spacing, the layer of build material has energy applied thereto from the energy source to cause fusion in at least part of the layer of build material. In some examples, fusion may occur in regions of the build material which have been treated with a coalescing agent. Therefore, the fusion of a layer may be partial, occurring in those regions which have been treated but not in untreated regions. In some examples, a coalescing agent may be added before, during or after block 104 or 106. In other examples, fusion may be controlled to occur in at least part of the layer using other techniques.

In some examples, reducing the spacing between the energy source and the support may comprise reducing a vertical spacing. In some examples, in an orthogonal xyz three-dimensional coordinate system, the support may be in an xy plane, and the distance between the energy source and the support in may be reduced in the z direction. In some examples, the energy source may also move relative to the support in the xy plane, for example scanning across the surface of the support.

According to some examples, the same energy source may perform both preheating and fusion. FIGS. 2A and 2B are schematic diagrams illustrating the effect of changing a spacing between an energy source and a support. In FIGS. 2a and 2b, an energy source 202 supplies energy which is incident on a support 204. In FIG. 2A, there is a spacing 206a between the energy source 202 and the support 204. In FIG. 2A, the energy source 202 irradiates substantially the entire support 204 as indicated by the rays 208 illustrating the edges of the beam supplied by the energy source 202. In FIG. 2B, there is a spacing 206b which is reduced compared to the spacing 206a in FIG. 2A. As the beam from the energy source 202 is diverging, the beam is smaller at the point where it is incident on the support 204, meaning an outer region 210 thereof is outside the beam, which is incident on an inner region 212. However, as a beam diverges, the energy of a unit area of the beam cross section decreases. Therefore, each unit area of the support 204 on which the beam is incident (i.e. in the inner region 212) receives more energy when the configuration is as indicated in FIG. 2B than when the configuration is as indicated in FIG. 2A.

In other words, when the support 204 is relatively closer, it will be subjected to more intense energy levels than when it is relatively further away. Taking an example of an energy beam having a circular cross section and radiating from a point source, and assuming that the beam cross sectional area is not greater than the support 204 at any distance, if for example the distance between the energy source 202 and the support 204 is halved, then the energy per unit area within the inner region 212 is quadrupled. Therefore, while the energy concentration may be suitable for preheating when the spacing is as shown in FIG. 2A, it will be relative more intense, and therefore may be suited to fusing when in the spacing is as shown in FIG. 2B. Therefore, these two configurations may be respectively referred to a preheating configuration and a fusing configuration.

By using the same energy source for both preheating and fusion, the complexity of an apparatus, and/or control thereof, may be reduced. In addition, the energy consumption may be lower as there will inefficiencies of a single energy source (both in terms of energy supply efficiency and energy application efficiency), rather than of two energy sources. It may also be the case that energy losses (for example due to absorption or reflection of electromagnetic radiation between the energy source and the surface of the build material) are reduced when the energy source 202 is closer to the support 204. This may result in a change of the energy delivered independently of beam divergence. As is further discussed below, the intensity of the energy source 202 may also be changed between the two configurations for example in a predetermined manner and/or in response to a signal such as an indication of a temperature.

In some examples of additive manufacturing, preheating is carried out by an energy source which is placed bearing in mind the positon of a print agent distributor for applying a fusing agent. This may mean that the energy source is around 200 mm from the print bed. However, during fusion, the print agent distributor may not be used and may be moved away from the print bed, and in such examples the energy source 202 may be repositioned to a location which does not have to accommodate the print agent distributor. In such an example, the separation during fusing may be around 100 mm.

It will be appreciated that, as the build material on the outer region 210 of the support 204 is outside the beam cross section when the apparatus is in the fusing configuration, in this example, object generation should be carried out within the inner region 212 of the support 204. In some examples, the spacing between a support 204 and an energy source 202 may for example be approximately halved between the preheating and fusing configurations.

In examples of additive manufacturing, a print bed may be movably mounted, and may be moved downwards within a fabrication chamber as new layers of build material are added thereto. This movement is generally the thickness of the layer, which may be around 0.1-1 mm per layer. Therefore, it may be that changing the spacing between a support and an energy source comprises moving the support (e.g. a print bed, or a print bed bearing build material) as the mechanisms for achieving this are already established. However, in other examples, the energy source could be moved relative to a static support. In some examples, there may be separate adjustment mechanisms for a print bed and an energy source. For example, it may be the case that large movements of the print bed may consume more energy (in particular as the print bed becomes overlaid with layers of build material, and therefore increases in weight) than moving an energy source, and/or it may be intended to control the placement of the print bed to a higher degree of precision than the placement of the energy source. It may also be the case that it is quicker to move an energy source than a print bed. In some examples, the energy source could be moved to provide a ‘rough’ spacing, and the print bed could be moved to finely adjust this spacing.

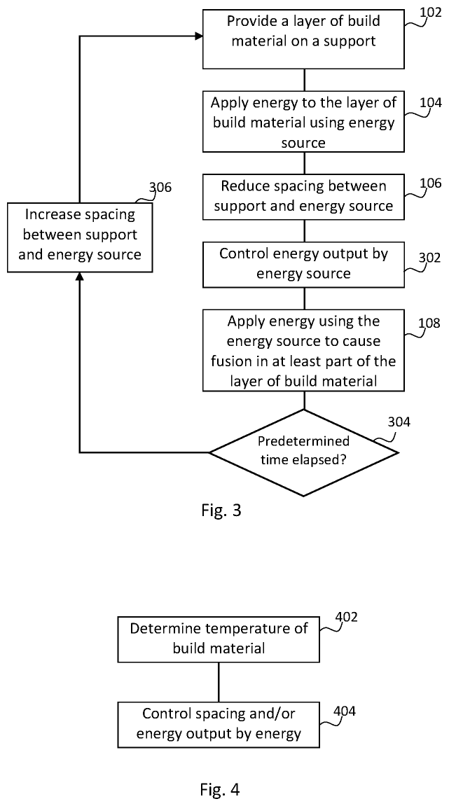

FIG. 3 shows an example of a method comprising the blocks set out above in relation to FIG. 1. In addition, after or as the spacing between the support and the energy source is reduced, in block 302, the energy source is controlled so as to change the intensity of energy supplied thereby. In some examples, the energy output may be increased, for example to the maximum energy output for that energy source, or the maximum beneficial energy for additive manufacturing. Controlling the energy source may comprise changing a power level, changing an intensity level (for example, changing a beam size by focussing or defocussing a beam), or any other control which changes the amount of energy applied to a layer of build material. Further, the process of block 108, i.e. using the energy source to cause fusion in at least part of the build material continues until a predetermined period of time has passed (block 304). This period of time may for example be determined according to the energy per unit area, the particular build material and/or print agents (if any) used, or some other factor. The predetermined time period may be determined so as to ensure the intended fusion occurs. Once the period of time has passed, the spacing between the support and the energy source is increased (block 306), and the method returns to block 102 and may repeat until an object is fully generated. Before, during or after the spacing is reduced, the energy supplied but the energy source may also be reduced. In some examples, the energy output by the energy source may be controlled during preheating and/or fusion, for example to ensure that a predetermined temperature distribution is seen. Thus blocks 104 and 108 may comprise controlling the energy supplied by the energy source. Some examples of such methods are described in relation to FIG. 4 below.

FIG. 4 shows an example of a method comprising feedback based on a temperature. This method may be used during preheating (for example, during block 104) or during fusing (for example during block 108). The method comprises, in block 402, determining a temperature of the build material. In some examples, this may be a temperature or a temperature distribution in a layer, for example the upper most layer, of build material. In block 404, the method further comprises controlling at least one of the spacing between the energy source and the support and the energy supplied by the energy source based on the determined temperature.

For example, it may be the case that during preheating, a substantially consistent temperature is intended across the whole of a print bed. This temperature may be intended to be close to, but below, a temperature to initiate or cause fusing (for example, a melting point) of the build material. If the build material as a whole is warmer or cooler than intended, the energy output by the energy source could be controlled-increased to increase the temperature, or decreased to decrease the temperature. The temperature could also or alternatively be affected by changing the spacing between the energy source and the support. This effectively allows the preheating distance to be redefined based on temperature feedback.

Similar measurements can be undertaken when the apparatus is in the fusing configuration. In such a case, it may be that a particular temperature should be reached in order for the material to fully fuse. If the temperature lower than intended, the spacing could be adjusted so that a support may be closer to the energy source and/or the energy supplied thereby may be increased. If however the temperature is higher than intended, this may result in an object having unintended characteristics, and the spacing could be increased and/or the energy supplied to build material by an energy source could be reduced.

In some examples the temperature may show an unintended temperature distribution. In that case, the energy source may be controllable to rectify the temperature distribution, for example if the energy source comprises an array of individually controllable energy sources, the energy output by each of these could be controlled. Such individual energy sources may also be movably mounted such that the individual spacing thereof with respect to the support may be controlled in light of a detected temperature distribution. In an example, a lamp array may be used, and the energy of each lamp of the array controlled to result in an approximately uniform temperature distribution over the layer of build material on the support.

The spacing between the energy source and the support may be controlled to set the temperature range. In an example, temperature ranges in preheating configuration could be between around 150° C. and 200° C. while temperature ranges in fusing configuration could be from around 180° C. to 260° C., while in both configurations, independent lamp power control in the lamp array is carried out to attain a substantially uniform temperature distribution control over the print bed and/or for fine control of the temperature within the range. There may be a range of spacings associated with fusing, and/or a range of spacings associated with preheating. In some examples, there may be fine control within the range(s).

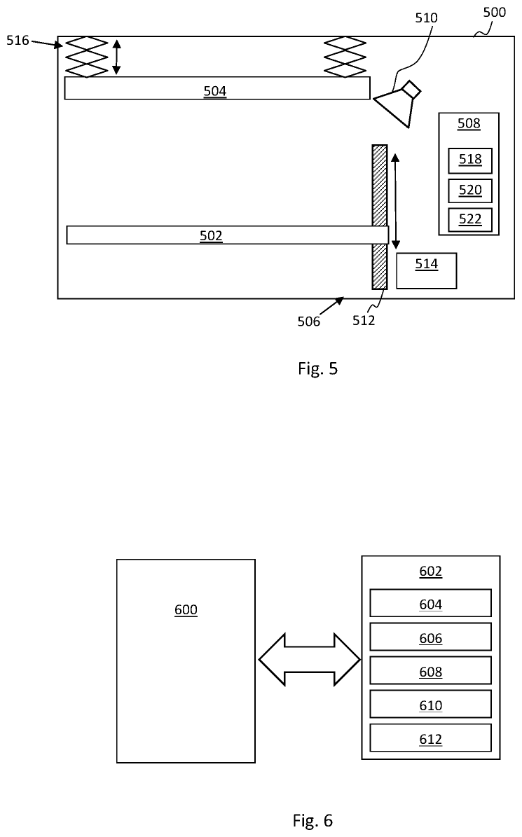

FIG. 5 shows an example of an additive manufacturing apparatus 500. The apparatus 500 comprises a print bed 502, an energy source 504, a print bed adjustment mechanism 506, an energy source adjustment mechanism 516, a controller 508 and, in this example, a temperature monitor 510.

The print bed 502 is to receive granular build material in a layer-wise manner. For example build material may be supplied from a hopper, by a spreader roller or the like. The energy source 504 is to irradiate build material to cause selective fusion thereof. In this example the energy source 504 comprises a two dimensional array of heat lamps (e.g. short wave (including infrared or near infrared) sources, which may be LEDs), although any suitable energy source may be used. The print bed adjustment mechanism 506 is to adjust the position of the print bed 502. In this example the adjustment mechanism comprises a drive screw 512 associated with a motor 514. The drive screw 512 is turned by the motor 514, which in turn is controlled by the controller 508. Turning the screw 512 raises or lowers the print bed 502. The energy source 504 is also mounted on an energy source adjustment mechanism 516, in this example a scissors mechanism. Adjusting either or both the adjustment mechanisms 506, 516 may change a distance between the print bed 502 and the energy source 504. The controller 508 comprises processing apparatus, the processing apparatus comprising a print bed adjustment module 518 to control the print bed adjustment mechanism 506, and an energy source adjustment module 520 to control the energy source adjustment mechanism 516. At least one of the adjustment modules 518, 520 may be to adjust the distance between the print bed and the energy source between at least one preheating distance and at least one fusing distance, wherein the print bed is relatively closer to the energy source when the distance between the print bed and the energy source is the fusing distance when than the distance between the print bed and the energy source is the preheating distance.

In use of the apparatus 500, the energy source adjustment module 520 may be to position the energy source 504 in at least one preheating position and at least one fusing position, wherein the energy source 504 is relatively closer to the print bed 502 when in a fusing position than when in a preheating position. The print bed adjustment module 518 may further control the print bed adjustment mechanism 506 such that the print bed 502 is repositioned for each layer of build material is received thereby and/or to provide fine adjustment of the spacing between the print bed 502 and the energy source 504. In some examples, the adjustment modules 518, 520 are to control the adjustment mechanisms 506, 516 such that the difference between the preheating distance and the fusing distance remains substantially the same for each layer of build material.

Some examples of adjustment mechanisms 506, 516 have been described above. Other examples include pulley mechanisms, chain mechanisms, stepper motors, and the like.

In this example the controller 508 further comprises an energy source control module 522 to control the energy output by the energy source 504. In some examples, the controller 508 may be to control the energy source 504 such that the energy emitted thereby is greater when the print bed 502 is in the fusing position than when the print bed 502 is in the preheating position.

The temperature monitor 510 monitors the temperature of at least a portion of the build material, for example the surface temperature thereof. In an example, the temperature monitor 510 may comprise an infrared camera array, a laser temperature meter, discrete temperature sensors, for example arranged on or about the print bed, or the like. In this example, the temperature monitor 510 provides an output indicative of at least one temperature to the controller 508, and the controller 508 may control at least one of the amount or intensity of energy emitted by the energy source 504 and the distance between the energy source 504 and the print bed 502 in response to an output of the temperature monitor 510. For example, if a temperature is higher than anticipated, the distance between the print bed 502 and the energy source 504 may be increased, and/or the energy supplied by the energy source 504 reduced. Conversely, if a temperature is lower than anticipated, the distance between the print bed 502 and the energy source 504 may be reduced, and/or the energy supplied by the energy source 504 increased. In other examples, the temperature may have an effect on a time period allowed for preheating or fusing. For example, preheating and/or fusing may continue until an anticipated temperature or temperature profile is seen. In some examples, the energy supplied by the energy source 504 may be controlled so as to obtain an intended (for example, uniform) temperature distributions over a layer of build material.

In examples, such apparatus 500 may comprise further components not described in detail herein. For example, the apparatus 500 may comprise a print agent distributor for applying a print agent, which may be mounted on a carriage or the like, and may in some examples make use of inkjet technology. The apparatus 500 may further comprise apparatus for directing energy emitted from the energy source 504, and/or apparatus for focusing or defocusing energy emitted thereby. Build material and/or print agent hoppers, build material spreading apparatus, user interfaces, additional control functions to control aspects of the additive manufacturing apparatus 500, etc. may also be provided in examples.

FIG. 6 is an example of a processor 600 associated with a computer readable medium 602. The computer readable medium 602 may comprise a memory or the like. The computer readable medium 602 comprises a set of instructions which, when executed by the processor 600, cause the processor 600 to carry out processes. In particular, in this example, the computer readable medium 602 comprises instructions 604 to cause the processor 600 to control a spacing between an energy source 504 and build material within an additive manufacturing apparatus to be a first spacing. The build material may comprise a layer of build material, for example an upper layer of build material within an additive manufacturing apparatus. The computer readable medium 602 further comprises instructions 606 to cause the processor 600 to, while the energy source 504 and build material have the first spacing, control the energy source 504 to preheat the build material. The computer readable medium 602 further comprises instructions 608 to cause the processor 600 to control a spacing between an energy source 504 and build material within an additive manufacturing apparatus to be a second spacing. The computer readable medium 602 further comprises instructions 610 to cause the processor 600 to, while the energy source 504 and build material have the second spacing, control the energy source 504 to cause at least partial fusing of the build material.

The processor 600 may act as a controller for an additive manufacturing apparatus, for example the controller 508 of the additive manufacturing apparatus 500 of FIG. 5.

In some examples, the computer readable medium 602 further comprises instructions 612 which, when executed by the processor 600, cause the processor 600 to control the duration for which the energy source 504 and the build material have at least one of the first or second spacing. In some examples, the duration may be predetermined. In other examples, the duration may be controlled based on feedback, for example a measured temperature.

In some examples, the computer readable medium 602 further comprises instructions 604 to cause the processor 600 cause the processor 600 to monitor at least one temperature over surface of the build material; and to control, according to the temperature, at least one of (i) the first spacing, (i) the second spacing, (iii) the energy source, (iv) the duration for which the energy source 504 and the build material have the first spacing, or (v) the duration for which the energy source 504 and the build material have the second spacing. In some examples, a temperature distribution may be measured.

Examples in the present disclosure can be provided as methods, systems or machine readable instructions, such as any combination of software, hardware, firmware or the like. Such machine readable instructions may be included on a computer readable storage medium (including but is not limited to disc storage, CD-ROM, optical storage, etc.) having computer readable program codes therein or thereon.

The present disclosure is described with reference to flow charts and block diagrams of the method, devices and systems according to examples of the present disclosure. Although the flow diagrams described above show a specific order of execution, the order of execution may differ from that which is depicted. Blocks described in relation to one flow chart may be combined with those of another flow chart. It shall be understood that each block in the flow charts and block diagrams, as well as combinations of the blocks in the flow charts and/or block diagrams can be realized by machine readable instructions.

The machine readable instructions may, for example, be executed by a general purpose computer, a special purpose computer, an embedded processor or processors of other programmable data processing devices to realize the functions described in the description and diagrams. In particular, a processor or processing apparatus may execute the machine readable instructions. Thus functional modules of the apparatus and devices such as the controller 508 and/or the modules thereof may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices may for realize functions specified by blocks in the flow charts and/or in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example herein may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A method comprising:
providing a layer of build material on a support;
applying energy to the layer of build material using an energy source;
reducing a spacing between the energy source and the support; and
following the reduction of the spacing, applying energy to the layer of build material using the energy source to cause fusion in at least part of the layer of build material.

2. A method according to claim 1 in which applying energy to the layer of build material using the energy source to cause fusion in at least part of the layer of build material comprises increasing the energy applied by the energy source.

3. A method according to claim 1 in which applying energy to the layer of build material using the energy source to cause fusion in at least part of the layer of build material comprises applying energy from the energy source for a predetermined period of time.

4. A method according to claim 1 further comprising:
determining a temperature of the build material and controlling at least one of the spacing between the energy source and the support and the energy supplied by the energy source based on the temperature.

5. A method according to claim 1 further comprising, after using the energy source to cause fusion in at least part of the layer of build material:
increasing the spacing between the energy source and the support;
providing a further layer of build material;
applying energy to the further layer of build material using the energy source;
reducing a spacing between the energy source and the support; and
following the reduction of the spacing, applying energy to the layer of build material using the energy source to cause fusion in at least part of the layer of build material.

6. Additive manufacturing apparatus comprising:
a print bed to receive granular build material in a layer-wise manner;
an energy source to irradiate the build material to cause selective fusion thereof;
at least one adjustment mechanism to adjust a distance between the print bed and the energy source;
a controller, the controller comprising at least one adjustment module to control at least one adjustment mechanism to adjust the distance between the print bed and the energy source between at least one preheating distance and at least one fusing distance, wherein the print bed is relatively closer to the energy source when the distance between the print bed and the energy source is a fusing distance than when the distance between the print bed and the energy source is a preheating distance.

7. Additive manufacturing apparatus according to claim 6 in which the controller further comprises an energy source control module to control the energy source such that the energy emitted thereby is greater when the distance between the print bed and the energy source is a fusing distance than when the distance between the print bed and the energy source is a preheating distance.

8. Additive manufacturing apparatus according to claim 6 in which at least one adjustment mechanism is to adjust the position of the energy source within the apparatus.

9. Additive manufacturing apparatus according to claim 6 in which the controller is further to control at least one adjustment mechanism such that the print bed is repositioned for each layer of build material is received thereby.

10. Additive manufacturing apparatus according to claim 6 in which the energy source is to cause heating of build material and the apparatus further comprises a temperature monitor to monitor the temperature of at least a portion of build material.

11. Additive manufacturing apparatus according to claim 10 in which the controller is to control at least one of the energy emitted by the energy source and the position of at least one of the energy source and the print bed in response to an output of the temperature monitor.

12. Additive manufacturing apparatus according to claim 6 in which the energy source comprises at least one heating lamp.

13. A computer readable medium comprising instructions which, when executed by a processor, cause the processor to:
control a spacing between an energy source and build material within an additive manufacturing apparatus to be a first spacing;
while the energy source and build material have the first spacing, control the energy source to preheat the build material;
control a spacing between an energy source and build material within an additive manufacturing apparatus to be a second spacing; and
while the energy source and build material have the second spacing, control the energy source to cause at least partial fusing of the build material.

14. A computer readable medium according to claim 13 further comprising instructions which, when executed by a processor, cause the processor to:
control the duration for which the energy source and the build material have at least one of the first or second spacing.

15. A computer readable medium according to claim 14 further comprising instructions which, when executed by a processor, cause the processor to:
monitor at least one temperature distribution over surface of the build material; and
control, according to the temperature, at least one of the first spacing, second spacing, the energy source, the duration for which the energy source and the build material have the first spacing, or the duration for which the energy source and the build material have the second spacing.
